(19) United States
(12) Patent Application Publication
(10) Pub. No.: US 2006/0097617 A1
(43) Pub. Date: May 11, 2006

(54) Cathode unit for fluorescent lamps

(76) Inventor: Robert Emmett Cassidy, Lebanon, NH (US)

Correspondence Address: Edwards & Angell, LLP, P. O. Box 55874, Boston, MA, 02205, US

(21) Appl. No.: 10/985,114

(22) Filed: Nov. 10, 2004

(51) Int. Cl. H01K 1/02; H01J 1/15; H01J 1/88; H01J 19/08; H01J 19/42

(52) U.S. Cl. 313/341; 313/343; 313/271

(57) ABSTRACT

Disclosed are cathode units for use in fluorescent discharge lamps which include a stem element adapted for sealing engagement with an end of an elongated vitreous/glass tube, first and second electrode support wires extending axially through the stem element, and a filament electrode which is oriented substantially axially with respect to the support wires. The support wires each have a inwardly-directed tip portion and the filament electrode is attached thereto. The ends of the filament electrode are attached to the support wires by welding. In alternative embodiments, the disclosed cathode unit can further include an electrode shield assembly.

### BACKGROUND OF THE INVENTION

1. Field of the Invention

The subject disclosure relates to cathode units for fluorescent lamps, and more particularly to cathode units that is adapted and configured for improving the service life of high-output fluorescent lamps, and still further to cathode units which includes an electrode shield assembly and/or an axially-oriented filament.

2. Background of the Related Art

Fluorescent discharge lamps have been in existence for many decades. Fluorescent lamps consist primarily of a sealed elongated vitreous tube which has an interior surface coated with phosphor powders. An electrode assembly or cathode unit is mounted on each of the sealed ends of the tube and is connected to base pins that engage with a lamp housing or ballast. During assembly, the elongated tube is vacuum purged and filled with a rare gas, such as argon, and a drop of mercury.

Fluorescent lamps typically operate at a relatively low pressure. In operation, an alternating current is applied to the cathode unit, which increases the filament temperature and causes the emission of electrons therefrom. These electrons are accelerated by the voltage across the tube until they collide with the mercury atoms, causing them to be ionized and excited. When the mercury atoms return to their normal state, mercury spectral lines in both the visible and ultraviolet region are generated. The ultraviolet radiation excites the phosphor coating to luminance. The resulting output is not only much higher than that obtained from the mercury lines alone, but also results in a continuous spectrum with colors dependent upon the phosphors used.

The service life for a fluorescent lamp is counted in hours of burning time and is mainly dictated by the service life of the cathode units. The cathode unit includes a filament or electrode which is coated with an emissive material. When the filament has lost most of its emissive material, its electron emitting capacity drops to such an extent that the tube will either not start or will enter a flickering stage which rapidly pulverizes the remaining emissive material.

As described in patent publication WO 81/01344, the loss of the emissive material from the surface of the filament and the concomitant reduction in the service life of the fluorescent tube are caused, in principle by three different processes, namely 1) the removal of emissive material due to ion bombardment; 2) the vaporization of the emissive material; and 3) chemical reactions between the emissive material and gaseous impurities in the tube. Therefore, in order to improve the service life of such lamps, the tubes must be designed in such a way that these three factors are taken into account. More specifically, in order to improve the service life of the cathode unit the vaporized ions and molecules must be reflected back to the filament surface to a considerable extent so that the cathode temperature remains moderate during the actual start-up period.

One attempt to improve the service life of the cathode unit is discussed in patent publication WO 81/01344, which is herein incorporated by reference. This publication discloses the use of a cathode shield, consisting of a box-shaped casing, the bottom of which has an opening permitting the cathode to be inserted into the interior of the box, and sealing the end of the box with a disc provided with a centrally located hole and made of electrically insulated material. Although, the disclosed shield assembly improves the service life of a cathode unit by reflecting back to the filament surface, ions and molecules that have been released through ion bombardment and vaporization, further improvement in maintaining the quality of the emissive coating on the filament is required in high-output (i.e., greater than 800 mA) applications such as, for example, tanning lamps.

There is a need, therefore, for a cathode unit with improved service for use in fluorescent lamps used in high output applications.

### SUMMARY OF THE INVENTION

The present disclosure is directed to cathode units for use in fluorescent discharge lamps. A typical fluorescent lamp includes an elongated vitreous tube with sealed axially opposed ends, a first cathode unit associated with one end of the tube and a second cathode unit associated with the other end.

An embodiment of the cathode unit of the present invention includes a stem element adapted for sealing engagement with an end of an elongated vitreous/glass tube, first and second electrode support wires extending axially through the stem element, and a filament electrode which is oriented substantially axially with respect to the support wires. The filament electrode has a first end connected to the first electrode support wire and a second end connected to the second electrode support wire. In a preferred embodiment, the support wires each have a inwardly-directed tip portion and the filament electrode is attached thereto. Still further, it is preferred that the inwardly-directed tip portion of the support wire includes a flatten land section for facilitating attachment of the filament electrode thereto. It is also envisioned that the filament electrode is coated with an emissive material.

In a preferred embodiment, the ends of the filament electrode are attached to the support wires by welding. Alternative means for attaching the filament electrode can be used, such as for example, clamping.

It is envisioned that an embodiment of the disclosed cathode unit can further include an electrode shield assembly. The electrode shield assembly has a disk portion and a cylindrical portion which extends axially therefrom. The disk portion is positioned perpendicular to the axis over which the first and second electrode support wires extend. The cylindrical portion surrounds the filament electrode and preferably has diameter smaller than the diameter of the disk portion.

The present disclosure is also directed to cathode units for use in a high output fluorescent lamps. The cathode units include, inter alia, a stem element, first and second electrode support wires, a filament electrode and an electrode shield assembly.

The stem element is adapted for sealing the an end of the fluorescent lamp in a manner know to those skilled in the art. The first and second electrode support wires extend axially through the stem element and are supported by the stem element. The filament electrode has an emissive coating applied thereto and the first end of the electrode is connected to the first electrode support wire and a second end of the electrode is connected to the second electrode support wire. Preferably, the filament electrode is oriented substantially axially with respect to the support wires.

It is presently envisioned that the electrode shield assembly includes a disk portion and a cylindrical portion which extends from the disk portion. The disk portion attached to at least one of the electrode support wires and is positioned perpendicular to the axis through which the first and second electrode support wires pass. The cylindrical portion projects axially from the disk portion so as to surround the filament electrode. It is presently preferred that the diameter of the cylindrical portion is smaller that the diameter of the disk portion.

In an embodiment of the present invention the disk portion of the electrode shield assembly is made from a conductive metal and is attached directly to one or more of the support wires. In this embodiment it is envisioned that the disk portion of the electrode shield assembly can include at least one axially extending tab which attaches directly to one of the support wires.

In an alternative embodiment, the disk portion of the electrode shield assembly is made from a nonconductive material and has two apertures formed. Moreover, a metallic eyelet is disposed in each of the apertures formed in the disk and the electrodes pass through the eyelets. Those skilled in the art would readily appreciate that other means for attaching the nonconductive disk to at least one of the electrode support wires can be used without departing from the inventive aspects of the present disclosure.

Preferably, the ends of the filament electrodes are attached to the support wires by welding. Alternatively, the ends of the filament electrode can be clamped to the first and second support wires as is know to those skilled in the art.

The present disclosure is also directed to a cathode unit for use in a fluorescent lamp which has an elongated vitreous tube with axially opposed ends, a first cathode unit associated with one end of the tube and a second cathode unit associated with the other end. Each cathode unit includes, inter alia, a stem element adapted for sealing engagement with the end of the tube, first and second electrode support wires extending axially through the stem and into the tube and a filament electrode oriented substantially axially with respect to the support wires. The filament electrode has a first end connected to the first electrode support wire and a second end connected to the second electrode support wire.

The cathode unit further includes an electrode shield assembly having a disk portion and a cylindrical portion extending from the disk portion. The disk portion is positioned perpendicular to the axis through which the first and second electrode support wires pass. The cylindrical portion extends axially from the disk portion so as to surround the filament electrode. Preferably, the diameter of the cylindrical portion is smaller that the diameter of the disk portion and the disc portion acts as a heat shield.

### BRIEF DESCRIPTION OF THE DRAWINGS

So that those having ordinary skill in the art to which the disclosed cathode unit appertains will more readily understand how to make and use the same, reference may be had to the drawings wherein:

FIG. 1 provides a side elevational view of a fluorescent lamp constructed in accordance with an embodiment of the present invention;

FIG. 2A is a side elevational view of a stem seal having electrode support wires extending axially through its body and constructed in accordance with a preferred embodiment of the present invention;

FIG. 2B is a side elevational view of the flattened inwardly-extending tip portions of the support wires of FIG. 2A;

FIG. 2C is a side elevational view of a cathode unit constructed in accordance with a preferred embodiment of the present invention having an axially-oriented filament;

FIG. 3A is a side elevational view of a further embodiment of a cathode unit of the present invention wherein an electrode shield assembly is attached to the electrode support wires and is electrically isolated therefrom;

FIGS. 3B and 3C provide side elevational views of a method of constructing the cathode unit of FIG. 3A;

FIG. 4A is a top plan view of the disk portion of the shield assembly of FIG. 3B;

FIG. 4B is a cross-sectional view of the disk of FIG. 4A taken along axis Y-Y;

FIG. 5 is a side elevational view of the cylindrical portion of shield assembly shown in FIG. 3B;

FIG. 6A is a side elevational view of a further embodiment of the cathode unit of the present invention wherein the shield assembly is electrically coupled to one of the electrode support wires;

FIG. 6B is a cross-sectional view of the shield assembly of FIG. 6A;

FIG. 6C is a top plan view of the shield assembly of FIG. 6A; and

FIG. 7A is a plan view of the disk used in the shield assembly of FIG. 6A;

FIGS. 7B and 7C are cross sectional views of the disk used in the shield assembly of FIG. 7A taken about both axis X-X and Y-Y, respectively.

The present invention overcomes many of the prior art problems associated with. The advantages, and other features of the cathode unit disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

### DETAILED DESCRIPTION OF PREFERRED EMBODIMENTS

Reference is now made to the accompanying figures for the purpose of describing, in detail, preferred and exemplary embodiments of the present disclosure. The figures and accompanying detailed description are provided to describe and illustrate exemplary manners in which the disclosed subject matter may be made and used, and are not intended to limit the scope thereof.

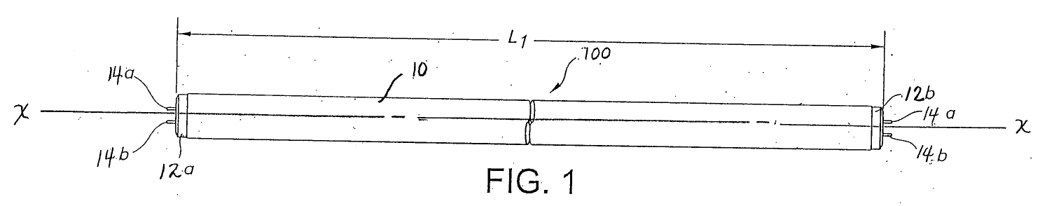

Referring now to FIG. 1, there is illustrated a typical fluorescent discharge lamp designated generally by reference numeral 100. Fluorescent lamp 100 includes, among other things, an elongated vitreous tube 10, first and second end caps 12a and 12b associated with each end of the tube, and first and second cathode units (not shown) also positioned at each end of tube 10. Tube 10 has an outer periphery which extends axially between the first and second end caps 12a and 12b. The overall length of tube 10 is identified as L₁. In a typical tanning application, the overall length of tube 10 is approximately 72 inches or 6 feet. The longitudinal axis for tube 10 is identified by reference line X-X. Throughout the present disclosure, the angular relationship of items associated with the lamp or cathode unit will be give with respect to this axis.

Contact pins 14a and 14b are provided on each end of lamp 100 and electrically communicate with the cathode units positioned within tube 10 and corresponding electrical contacts associated with a lamp housing or ballast unit. In an alternate embodiment, pins 14a and 14b can be replaced with a recessed double contact base or any other suitable electrical communication mechanism or arrangement, as will be readily appreciated by those skilled in the art.

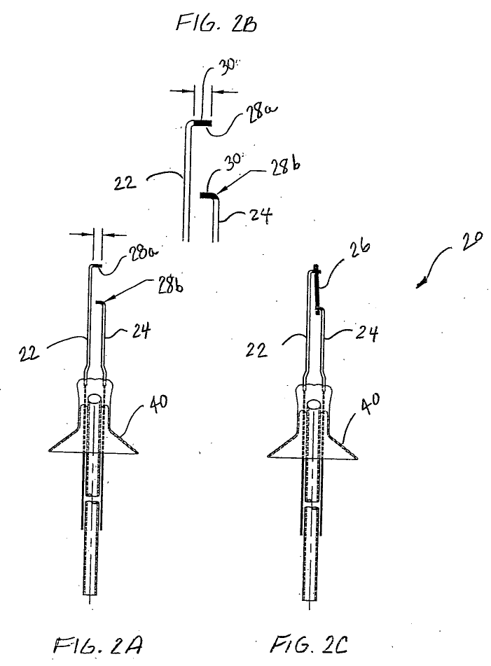

Referring now to FIGS. 2A and 2C which illustrate a cathode unit constructed in accordance with a preferred embodiment of the present invention and designated generally by reference numeral 20. Cathode unit 20 includes a stem seal 40 which is generally made from a non-conductive material, such as glass, and is adapted and configured for sealing the end of tube 10. Cathode unit 20 further includes first and second electrode support wires, 22 and 24 respectively, which extend axially through stem element 40 and are supported by stem element 40. A filament electrode 26 is oriented substantially axially with respect to the support wires 22/24 and has a first end connected to the first electrode support wire 22 and a second end connected to the second electrode support wire 24.

As best illustrated in FIG. 2B, the support wires 22/24 each have a inwardly projecting tip portion 28a/28b and the filament electrode 26 is attached thereto. In the embodiment disclosed herein, the inwardly-projecting tip portions 28a/28b of the support wires 22/24 each have a flattened land section 30 which is used to facilitate attaching the filament 26 thereto.

The ends of the filament electrode 26 are attached to the support wires by welding. The use of welding improves the flow of current through the cathode unit 20 and increases the life of the cathode unit, especially in very high output (VHO) lamps (i.e. greater than 1.5 A) and super high output lamps (i.e., greater than 2 A). Commonly used techniques, such as clamping, rely on mechanical resistance forces to secure the filament. However, in applications where the current exceeds 1.5 to 2.0 amps, the heat generated by the filament causes the mechanical connection to degrade, resulting in overheating of the filament and a shorter filament service life. Therefore, in VHO and SHO applications, welding the filament to the support wires is the preferred technique, but it is envisioned that clamping can be used.

Referring to FIG. 2C, the filament electrode 26 is coated with an emissive material (not shown). Orienting the filament 26 in a substantially axial manner as shown in FIG. 2C has several advantages. First, it allows the filament 26 to be centered in the lamp, thereby further centering the arc stream. Secondly, since the filament 26 is now positioned further away from the wall of tube 10, the heat applied to the glass surface and the discoloration of the glass caused by sputtering of the emissive coating on the filament surface is reduced.

As will be described in detail herein below, orienting the filament 26 along the lamp axis has a further advantage when used in embodiment of the present invention that include a cathode shield assembly. More specifically, vertically orienting the filament will allow a smaller diameter cathode shield to be used for reflecting back to the filament surface, ions and molecules that have been released through ion bombardment and vaporization.

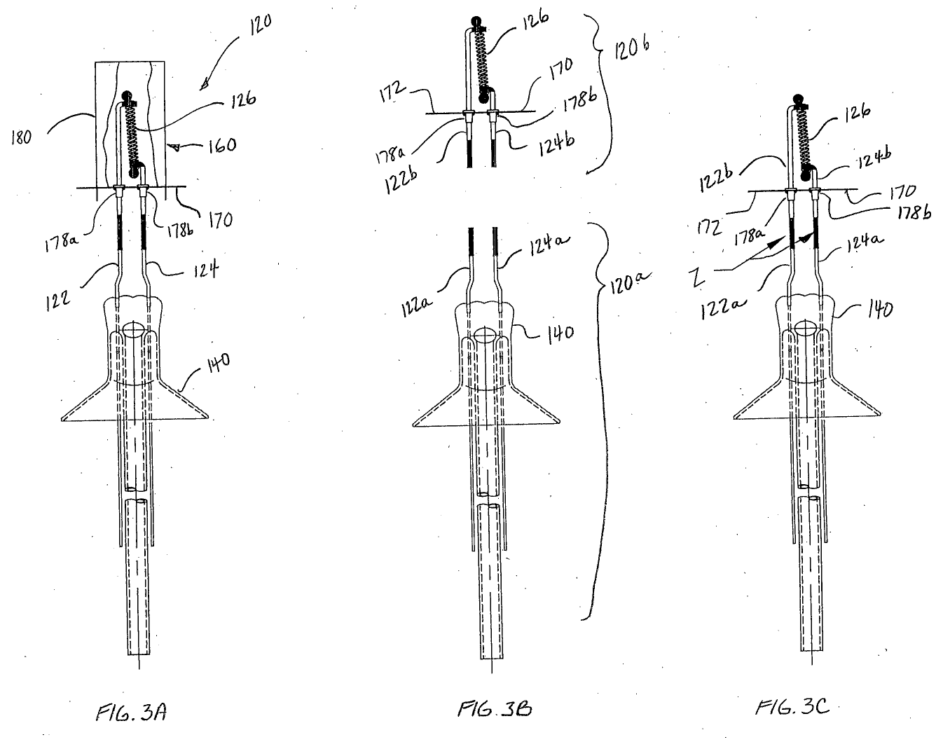

Referring now to FIGS. 3A through 3C which illustrate a further embodiment of the cathode unit of the present invention that has been designated by reference number 120. As shown in these figures, cathode unit 120 is similar in structure to cathode unit 20. Cathode unit 120 includes a stem seal 140 which is generally made from a non-conductive material, such as glass, and is adapted and configured for sealing the end of tube 10. Cathode unit 120 further includes first and second electrode support wires, 122 and 124 respectively, which extend axially through stem element 140 and are supported by stem element 140. A filament electrode 126 is oriented substantially axially with respect to the support wires 122/124 and has a first end connected to the first electrode support wire 122 and a second end connected to the second electrode support wire 124.

However, unlike cathode unit 20, cathode unit 120 includes an electrode shield assembly 160. The electrode shield assembly 160 has a disk portion 170 and a cylindrical portion 180. The disk portion 170 is arranged perpendicular to the axis through which the first and second electrode support wires 122/124 extend and the cylindrical portion 180 extends along the axis.

As shown in FIG. 3A, the cylindrical portion 180 of the electrode shield assembly 160, completely surrounds the axially-oriented filament electrode 126 and has diameter smaller than the diameter of the disk portion 170. The orientation of the filament 126 along the axis for the lamp allows the diameter of the cylindrical portion 180 of shield assembly 160 to be reduced dramatically in comparison to prior cathode shields. As a result, ions and molecules that have been released through ion bombardment and vaporization from the filament surface are more likely to be reflected back to the filament, thus, improving the service life of the cathode unit 120.

In addition to reflecting back ions and molecules to the filament surface, electrode shield assembly 160 acts as a heat shield for the lamp. More specifically, when cathode unit 120 is installed in a fluorescent lamp, a cold trap is formed behind the heat shield allowing the mercury to condense at the bottom of the tube. By orienting the filament 126 along the lamp axis and reducing the diameter of the cylindrical portion 180 of the shield assembly 160, a larger cold trap zone can be formed. This is especially important in VHO and SHO applications which have higher filament temperatures.

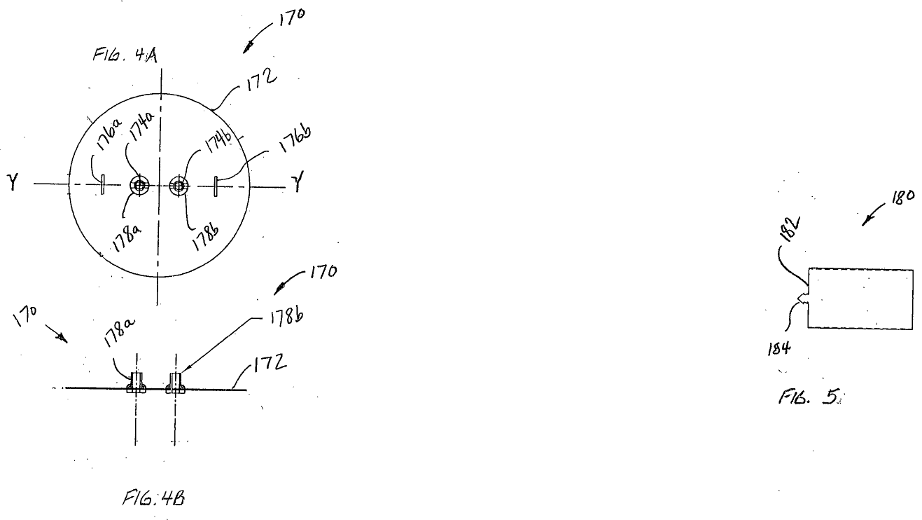

In the presently disclosed embodiment, although the electrode shield assembly 160 is attached directly to the electrode support wires, it is electrically isolated from the system. As shown in FIGS. 4A and 4B, the disk portion 170 of the shield assembly 160 includes a circular base 172 which is made from a non-conductive material, such as mica. The circular base 172 has two apertures 174a and 174b and two slits 176a and 176b formed therein. The apertures 174a/174b are spaced to coincide with the spacing of the support wires 122/124. Two metallic eyelets 178a and 178b have been inserted into the apertures 174a/174b using known techniques and are adapted and configured for engaging with the support wires 122/124. The two slits 176a/176b are spaced so as to receive two tabs 184a and 184b (not shown) which project from end 182 of the cylindrical portion 180 of the shield assembly (See FIG. 5). The cylindrical portion 180 of shield assembly 182 can be made from any heat dissipating material. In the presently disclosed embodiment, either an electrically conductive or non-conductive material can be used for the cylindrical portion 180. In embodiments where it is desired to have the shield assembly be in electrical connectivity with the support wires, a metal would be used for both the disk portion and the cylindrical portion of the shield assembly. During assembly, tabs 184a/184b of cylindrical portion 180 are inserted into the slits 176a/176b provided in the disk portion 170 and bent so as to securing the cylindrical portion 180 to the disk portion 170.

FIGS. 3B and 3C illustrate exemplary steps for assembling a cathode unit as constructed in FIG. 3A. As shown in FIG. 3B, the cathode unit 120 can be initially constructed in two halves 120a and 120b. An upper half 120b can include a portion of the electrode support wires 122b/124b, the mica disk portion 170 fixed to the support wires and the filament 126. The lower half 120a can include the stem element 140 and a portion of the support wires 122a/124a. The two halves 120a/120b are then welded together at the locations identified as “Z” and the cylindrical portion 180 of the shield assembly 160 is then attached to the mica disk portion 170.

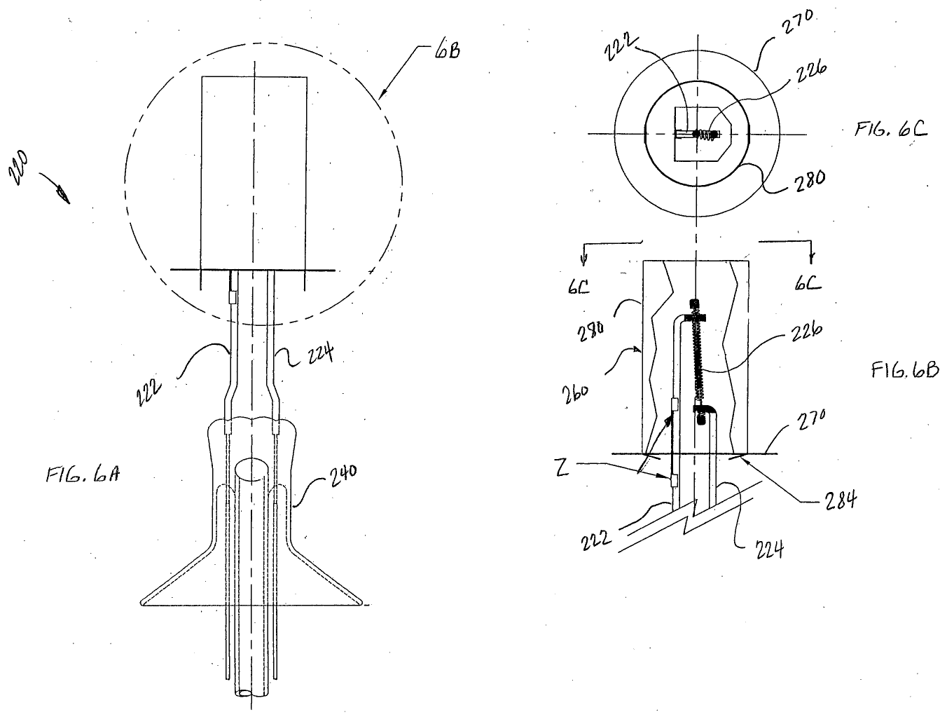

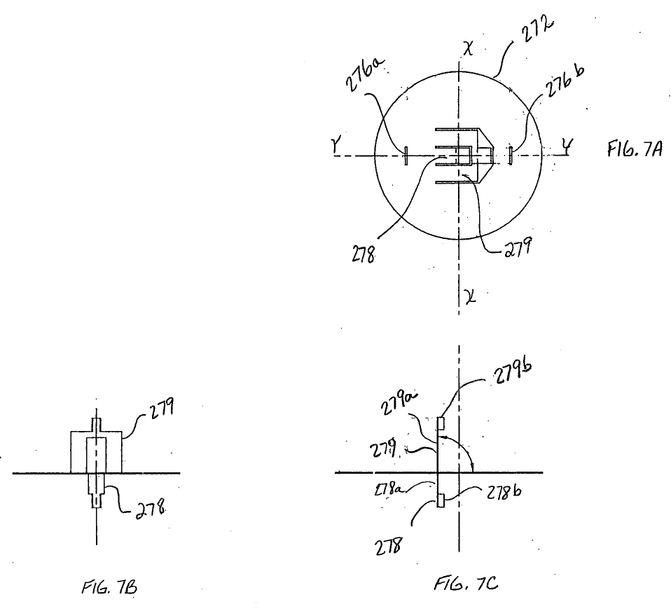

Referring now to FIGS. 6A, 6B and 7A through 7C, which illustrate a further embodiment of the cathode unit of the present invention designated as reference numeral 220. Cathode unit 220 is similar in structure and function to cathode unit 120 in that it includes a stem seal 240 which is adapted and configured for sealing the end of a tube, first and second electrode support wires, 222 and 224 respectively, which extend axially through stem element 240 and are supported by stem element 240, and a filament electrode 226. Filament electrode 226 is oriented substantially axially with respect to the support wires 222/224 and has a first end connected to the first electrode support wire 222 and a second end connected to the second electrode support wire 224.

However, unlike cathode unit 120, the shield assembly 260 used in cathode unit 220 is electrically connected to the support wires 222/224. Like before, cathode unit 220 includes a shield assembly 260 having a disk portion 270 and a cylindrical portion 280, but in this embodiment, the disk portion 270 and cylindrical portions 280 are made from electrically conductive material. It is envisioned that the cylindrical portion can be made from a non-conductive material, such as mica. Additionally, the disk portion 270 is formed as best illustrated in FIG. 7A. As shown in this figure, the disk portion has a main body portion 272 which has an inner tab 278 and an outer tab 279 cut formed in its surface.

Tab 278 includes an arm section 278a and a curved portion 278b which is adapted for being welded to electrode support wire 222 at lower location Z (see FIG. 6B). Tab 279 also includes an arm section 279a and a curved portion 279b which is adapted for being welded to electrode support wire 222 at upper location Z (see FIG. 6B). A as result, cathode unit 220 is electrically connected to and supported by electrode support wire 222. Those skilled in the art will readily appreciate that tab 279 does not need to be welded to the support wire in order for the shield assembly 260 to be properly supported.

The combination of the vertical filament and the cylindrical heat shield further improves the service life of the cathode and eliminates the need for a shield cove, such as that disclosed in patent publication WO WO 81/01344, since the diameter of the shield can be much smaller than prior shield elements.

What is claimed is:

1. A cathode unit for use in a fluorescent lamp which includes an elongated vitreous tube with axially opposed ends, a first cathode unit associated with one end of the tube and a second cathode unit associated with the other end, each cathode unit comprising:
a) a stem element adapted for sealing engagement with the end of the tube;
b) first and second electrode support wires extending axially through the stem element; and
c) a filament electrode oriented substantially axially with respect to the support wires and having a first end connected to the first electrode support wire and a second end connected to the second electrode support wire.

2. A cathode unit as recited in claim 1, wherein the ends of the filament electrode are attached to the support wires by welding.

3. A cathode unit as recited in claim 1, wherein the ends of the filament electrode are clamped to the first and second support wires.

4. A cathode unit as recited in claim 1, wherein the filament electrode is coated with an emissive material.

5. A cathode unit as recited in claim 1, wherein the support wires each have a tip portion which projects inward and the filament electrode is attached thereto.

6. A cathode unit as recited in claim 5, wherein the tip portion of the support wires includes a flat surface for facilitating the welding of the filament thereto.

7. A cathode unit as recited in claim 1, further comprising an electrode shield assembly which includes:
a) a disk portion attached to at least one of the electrode support wires and positioned perpendicular to the axis through which the first and second electrode support wires pass;
b) a cylindrical portion extending axially from the disc portion so as to surround the filament electrode; wherein the diameter of the cylindrical portion is smaller than the diameter of the disk portion and the disk portion acts as a heat shield.

8. A cathode unit for use in an elongated fluorescent lamp comprising:
a) a stem element adapted for sealing engagement an end of the fluorescent lamp;
b) first and second electrode support wires extending axially through the stem element and supported thereby;
a filament electrode having an emissive coating applied thereto, wherein a first end of the electrode is connected to the first electrode support wire and a second end of the electrode is connected to the second electrode support wire; and
d) an electrode shield assembly which includes;
i. a disk portion attached to at least one of the electrode support wires and positioned perpendicular to the axis through which the first and second electrode support wires pass;
ii. a cylindrical portion extending axially from the disc portion so as to surround the filament electrode; wherein the diameter of the cylindrical portion is smaller that the diameter of the disk portion and the disc portion acts as a heat shield.

9. A cathode unit as recited in claim 8, wherein the filament electrode is oriented substantially axially with respect to the support wires.

10. A cathode unit as recited in claim 8, wherein the disk portion of the electrode shield assembly is made from an electrically conductive metal and is attached directly to one or more of the support wires.

11. A cathode unit as recited in claim 10, wherein the disk portion of the electrode shield assembly includes at least one axially extending tab which attaches directly to one of the support wires.

12. A cathode unit as recited in claim 8, wherein the disk portion of the electrode shield assembly is made from a nonconductive material and has two apertures formed therein that have two metallic eyelets disposed therein.

13. A cathode unit as recited in claim 8, wherein the ends of the filament electrodes are attached to the support wires by welding.

14. A cathode unit as recited in claim 8, wherein the ends of the filament electrode are clamped to the first and second support wires.

15. A cathode unit as recited in claim 8, wherein the support wires each have a radially-oriented tip portion and the filament electrode is attached thereto.

16. A cathode unit for use in a fluorescent lamp having an elongated vitreous tube with axially opposed ends, a first cathode unit associated with one end of the tube and a second cathode unit associated with the other end, each cathode unit comprising:
a) a stem element adapted for sealing engagement with the end of the tube;
b) first and second electrode support wires extending axially through the stem into the tube;
c) a filament electrode oriented substantially axially with respect to the support wires and having a first end connected to the first electrode support wire and a second end connected to the second electrode support wire; and
d) an electrode shield assembly which includes;
i. a disk portion attached to at least one of the electrode support wires and positioned perpendicular to the axis through which the first and second electrode support wires pass;
ii. a cylindrical portion extending axially from the disc portion so as to surround the filament electrode; wherein the diameter of the cylindrical portion is smaller that the diameter of the disk portion and the disc portion acts as a heat shield.
